(19) United States
(12) Patent Application Publication
(10) Pub. No.: US 2009/0034999 A1
(43) Pub. Date: Feb. 5, 2009

(54) IMAGE FORMING APPARATUS AND CONTROL METHOD THEREOF

(75) Inventor: Kenichi Komiya, Kawasaki-Shi (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/128,543

(22) Filed: May 28, 2008

Related U.S. Application Data
(60) Provisional application No. 60/957,147, filed on Aug. 21, 2007.
(60) Provisional application No. 60/953,439, filed on Aug. 1, 2007.

(51) Int. Cl. G03G 15/043

(52) U.S. Cl. 399/51

(57) ABSTRACT

An image forming apparatus of the invention includes: a laser beam source; a laser beam source control unit configured to control the laser beam source based on image data; a plurality of photoconductive members respectively corresponding to a plurality of colors; a single piece of polygon mirror whose reflection surfaces are disposed in a rotation direction thereof with a plurality of different inclination angles respectively corresponding to the plurality of colors, scans the photoconductive members sequentially for each of the colors in a main scanning direction; a beam detector that is disposed adjacent to the photoconductive member on an upstream side of the photoconductive member in the main scanning direction; and an adjustment data control unit configured to change, in synchronization with a detection signal coming from the beam detector, color-based adjustment data for adjusting variations of an image quality parameter resulted from the optical paths and the photoconductive members varying with the colors.

### BACKGROUND OF THE INVENTION

1. Field of the Invention

The present invention relates to an image forming apparatus and a control method thereof and, more specifically, to an image forming apparatus that forms images by electrophotography and a control method thereof.

2. Description of the Related Art

With an image forming apparatus such as copier, printer, and MFP (Multi-Functional Peripheral), previously, the electrophotography has been widely popular. With the electrophotography, a laser beam or others are directed to a photoconductive drum for forming an electrostatic latent image thereon, and the resulting electrostatic latent image is developed using a toner.

For an image forming apparatus of electrophotography, the tandem system has been well known for color printing. Such a tandem image forming apparatus generally includes four photoconductive drums respectively corresponding to four colors of yellow (Y), magenta (M), cyan (C), and black (K). The photoconductive drums each form a toner image of its own color in parallel, and the resulting toner images of four colors are transferred to a paper for overlay one on the other so that a full-color image is formed. These four images are processed almost at once in parallel, and thus printing of a full-color image can be completed at high speed.

With electrophotography, generally, the photoconductive drums are each formed with an electrostatic latent image on its surface by a laser beam scanning the photoconductive drums in the main scanning direction. The laser beam is the one coming from a laser beam source such as laser diode. For scanning in the main scanning direction as such, a rotating multi-faceted reflective member called polygon mirror is often used.

As described above, the tandem image forming apparatus includes four photoconductive drums respectively corresponding to four colors of Y, M, C, and K. Such a previous tandem image forming apparatus is of a general configuration including four laser beam sources and four polygon mirrors respectively corresponding to the four colors. As a result, the size of hardware is large compared with an image forming apparatus specifically for monochrome printing.

In consideration thereof, there is a technology for apparatus downsizing by putting a laser beam source and a polygon mirror in use for sharing, i.e., one laser beam source and one polygon mirror (an example includes US 2007/0279723 A1).

US 2007/0279723 A1 describes the technology for forming four different inclination angles (inclination angles with respect to the rotation axis) to a reflection surface of a polygon mirror disposed in a rotation direction thereof. With such a reflection surface formed with the different inclination angles, a laser beam entering from any one laser beam source is reflected in directions varying with colors in a direction range orthogonal to the main scanning direction (direction of an elevation angle), thereby directing the laser beam toward the four photoconductive drums disposed at each different position. With the technology described in US 2007/0279723 A1, an optical lens (e.g., f-θ lens) is also put in use for sharing for placement between the polygon mirror and each of the photoconductive drums, thereby being able to reduce the hardware size to a considerable degree.

The issue here is that, even if a polygon mirror is put in use for sharing as described above, the optical path varies before reaching the respective photoconductive drums from the polygon mirror. As a result, the optical paths from the polygon mirror to the respective photoconductive drums are not always the same in length.

The range of a scanning angle for scanning by the rotation of the polygon mirror in the main scanning direction is the same no matter which color. However, if the optical paths from the polygon mirror to the respective photoconductive drums vary in length, images on the photoconductive drums will vary in magnification (image size) in the main scanning direction depending on which color. This thus causes a problem of color drift when images of four colors are overlaid one on the other.

Moreover, on the optical paths from the polygon mirror to the respective photoconductive drums, a plurality of mirrors are disposed for changing the orientation of the optical paths. The reflection characteristics of these mirrors on the optical paths also vary to some degree depending on which color. Moreover, because the incident angle of a laser beam to the f-θ lens also varies with the inclination angles of the polygon mirror, the attenuation characteristics of the f-θ lens in the main scanning direction also vary to some degree with the colors.

When variations, with the colors, are observed in the reflection characteristics of the mirrors and the optical characteristics of the f-θ lens such as attenuation characteristics, the intensity of a laser beam to be received on the surfaces of the photoconductive drums also varies with the colors. As a result, the color of the resulting full-color image is not the color originally expected, thereby reducing the color reproducibility.

### SUMMARY OF THE INVENTION

The present invention is proposed in consideration of such circumstances, and an object thereof is to provide an image forming apparatus that can, in the course of scanning a plurality of photoconductive drums respectively corresponding to various colors with a laser beam by a single piece of polygon mirror whose reflection surfaces are formed with various different inclination angles respectively corresponding to the colors, reduce any variations of an image magnification possibly occurred in the main scanning direction depending on which color and any variations of a light-receiving level possibly occurred on the photoconductive drums depending on which color, eliminate any possible color drift, and achieve high color reproducibility, and a control method thereof.

In order to achieve the object above, an image forming apparatus in an aspect of the invention includes: a laser beam source; a laser beam source control unit configured to control the laser beam source based on image data; a plurality of photoconductive members respectively corresponding to a plurality of colors; a single piece of polygon mirror whose reflection surfaces are disposed in a rotation direction thereof with a plurality of different inclination angles respectively corresponding to the plurality of colors, and via a plurality of different optical paths respectively corresponding to the inclination angles, the polygon mirror scanning the photoconductive members with a light coming from the laser beam source sequentially for each of the colors in a main scanning direction; a beam detector that is disposed adjacent to the photoconductive member on an upstream side of the photoconductive member in the main scanning direction; and an adjustment data control unit configured to change, for output to the laser beam source control unit, in synchronization with a detection signal coming from each of the beam detectors, color-based adjustment data for adjusting variations of an image quality parameter resulted from the optical paths and the photoconductive members varying with the colors.

Moreover, a control method of an image forming apparatus in another aspect of the invention includes: controlling a laser beam source based on image data and color-based adjustment data; sequentially scanning, by a single piece of polygon mirror whose reflection surfaces are disposed in a rotation direction thereof with a plurality of different inclination angles respectively corresponding to a plurality of colors, for each of the colors, a plurality of photoconductive members provided to each of the colors in a main scanning direction, with a light coming from the laser beam source via a plurality of different optical paths respectively corresponding to the inclination angles; detecting a scanning timing in the main scanning direction by a beam detector that is disposed adjacent to the photoconductive member on an upstream side of the photoconductive member in the main scanning direction; and switching, in synchronization with a detection signal coming from each of the beam detectors, the color-based adjustment data for adjusting variations of an image quality parameter resulted from the optical paths and the photoconductive members varying with the colors.

### BRIEF DESCRIPTION OF THE DRAWINGS

In the accompanying drawings:

FIG. 1 is a perspective view of an image forming apparatus in a first embodiment of the invention, showing an exemplary outer appearance thereof;

FIG. 2 is a schematic cross sectional diagram showing an exemplary configuration of an image forming unit of the image forming apparatus in the first embodiment;

FIGS. 3A and 3C are each a diagram showing the characteristics of a polygon mirror in the first embodiment;

FIG. 4 is a diagram showing scanning by the polygon mirror in a main scanning direction;

FIG. 5 is a diagram illustrating the relationship between an optical path length and an image magnification, both varying from one color to another;

FIG. 6 is a block diagram showing an exemplary detailed configuration of a laser beam source control unit and that of an adjustment data control unit in the first embodiment;

FIG. 7 is a block diagram showing an exemplary configuration of a PLL circuit in the first embodiment;

FIG. 8 is a timing diagram related to a color-based switching of an image clock frequency;

FIG. 9 is a diagram showing an exemplary detailed configuration of a laser drive circuit and that of a laser beam source;

FIG. 10 is a timing diagram related to a color-based switching of various types of adjustment data in the first embodiment;

FIG. 11 is a timing diagram related to a color-based switching of various types of adjustment data in a first modified example of the first embodiment;

FIG. 12 is a block diagram showing an exemplary detailed configuration of a laser beam source control unit and that of an adjustment data control unit in the first modified example of the first embodiment;

FIG. 13 is a timing diagram related to a color-based switching of various types of adjustment data in a second modified example of the first embodiment;

FIG. 14 is a timing diagram related to a switching of an image clock frequency in a third modified example of the first embodiment;

FIG. 15 is a block diagram showing an exemplary detailed configuration of a laser beam source control unit and that of an adjustment data control unit in the third modified example of the first embodiment;

FIG. 16 is a block diagram showing an exemplary detailed configuration of a laser beam source control unit and that of an adjustment data control unit in a second embodiment, i.e., multi-beam; and

FIG. 17 is a timing diagram related to a color-based switching of various types of adjustment data in the second embodiment, i.e., multi-beam.

### DESCRIPTION OF THE PREFERRED EMBODIMENTS

By referring to the accompanying drawings, described are an image forming apparatus and a control method thereof in embodiments of the invention.

### 1. Configuration of Image Forming Apparatus

### First Embodiment

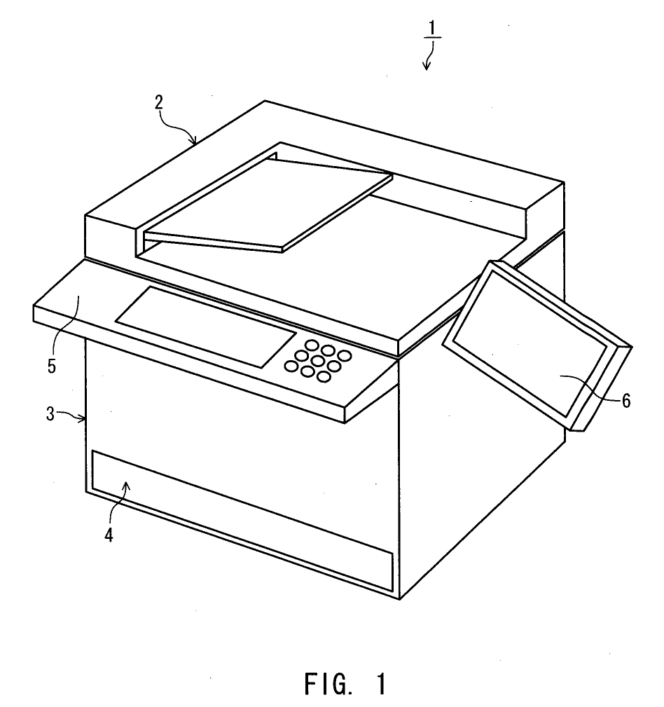

FIG. 1 is a diagram showing the outer appearance of a copier (or MFP) as a typical example of an image forming apparatus 1 of a first embodiment.

The image forming apparatus 1 is configured to include a reading unit 2, an image forming unit 3, a paper feed unit 4, and others.

The reading unit 2 generates image data by optically reading an original document placed on a document glass, or an original document input into an ADF (Auto Document Feeder).

The image forming unit 3 prints, by electrophotography, the image data onto a paper provided by the paper feed unit 4. The image forming unit 3 is provided with a control panel 5 for a user to make various types of operations, and a display panel 6 for displaying various types of information.

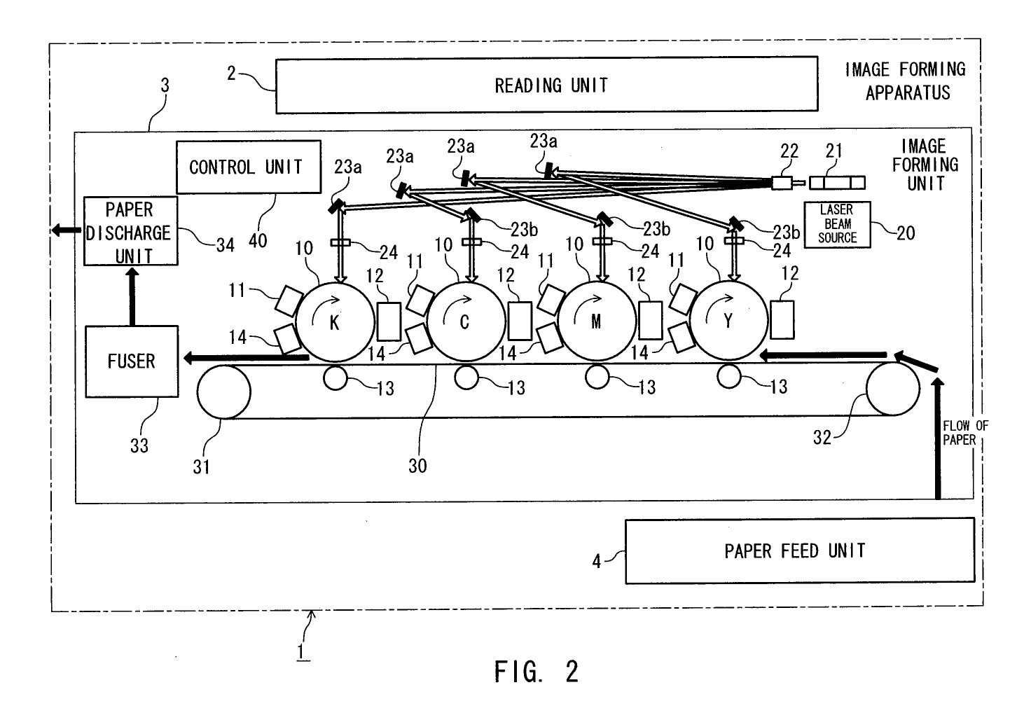

FIG. 2 is a schematic cross sectional diagram mainly showing an exemplary internal configuration of the image forming unit 3. The image forming apparatus 1 of this embodiment is of a tandem type, and is so configured as to be capable of color printing by electrophotography.

As shown in FIG. 2, four photoconductive drums 10 are disposed in line in the direction along which a paper is transferred. The four photoconductive drums 10 respectively correspond to four colors of yellow (Y), magenta (M), cyan (C), and black (K). Around each of the photoconductive drums 10, other components, i.e., a charging device 11, a developing device 12, a transfer roller 13, a cleaner 14, and others, are disposed in order from upstream to downstream of rotation. The developing devices 12 each carry its own color of toner but share the same configuration, and thus are provided with the same reference numeral.

The charging device 11 electrically charges the surfaces of the photoconductive drums 10 uniformly at a predetermined potential. The surfaces of the photoconductive drums 10 of the colors are then exposed with a laser beam that has been subjected to pulse width modulation in accordance with the level of image data of each of the colors Y, M, C, and K. Any portion exposed with the laser beam as such is reduced in potential so that an electrostatic latent image is formed on the surfaces of the photoconductive drums 10.

The developing device 12 serves to develop the electrostatic latent image formed as such on the photoconductive drums 10 using toners of the respective colors. As a result of such development, the photoconductive drums 10 are respectively formed with toner images of four colors Y, M, C, and K.

On the other hand, the paper feed unit 4 picks up a paper, and directs the paper on a transfer belt 30 from right to left in FIG. 2. In this course of paper transfer, first of all, at a position where the Y-use photoconductive drum 10 is opposing a Y-use transfer roller 13 (at a Y transfer position), a Y-toner image is transferred from the photoconductive drum 10 to the paper.

Next at a position where the M-use photoconductive drum 10 is opposing an M-use transfer roller 13 (at an M transfer position), an M-toner image is transferred from the photoconductive drum 10 to the paper. At this time, the M-toner image is so transferred as to be overlaid on the Y-toner image that is already on the paper.

Similarly, a C-toner image and a K-toner image are transferred by being sequentially overlaid on the paper so that a full-color toner image is formed on the paper. The resulting full-color toner image is fused onto the paper by being heated and pressed by a fuser 33. Thereafter, the paper is discharged to the outside of the image forming apparatus 1 by a paper discharge unit 34.

Any toner remained on the surfaces of the photoconductive drums 10 are removed by the cleaners 14 to be ready for the next paper printing. By repeating such a process, printing can be performed in a sequential manner.

With the image forming apparatus 1 in the first embodiment of the invention, as shown in FIG. 2, a single piece of laser beam source 20 and a single piece of polygon mirror 21 serve to divide and direct a laser beam to the photoconductive drums 10 disposed at four different positions.

A laser beam coming from the laser beam source 20 (laser laser beam source) is reflected by the polygon mirror 21 at an elevation angle varying with the colors. Thereafter, the resulting laser beams are each guided to a light exposure position of its corresponding photoconductive drum via an optical path varying with the colors. To be specific, the laser beam reflected by the polygon mirror 21 passes through an f-θ lens 22, and then reaches the light exposure position of each of the photoconductive drums via a primary mirror 23a, a secondary mirror 23b (no secondary mirror 23b for black (K)), and a cylindrical lens 24, which are provided to each of the colors.

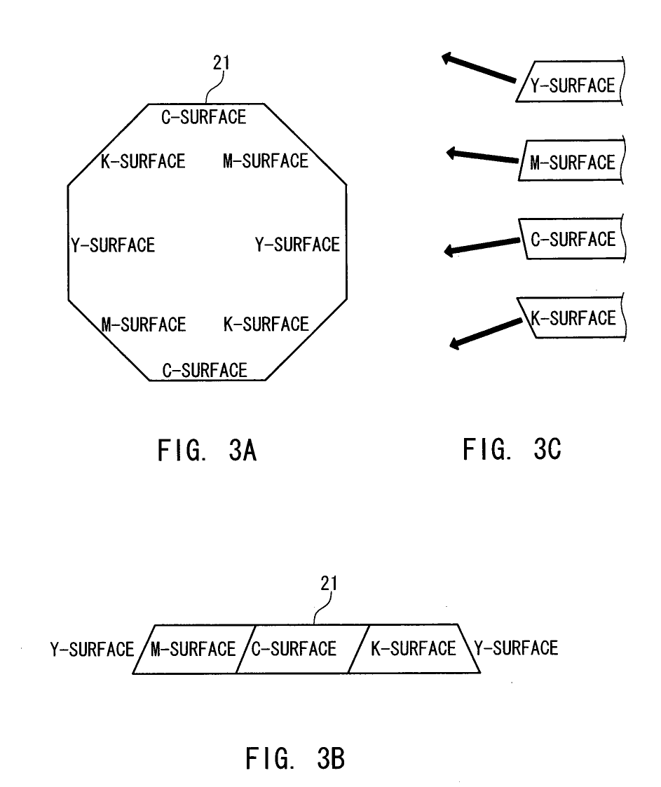

FIGS. 3A to 3C are each a diagram illustrating the characteristics of the polygon mirror 21 for use in the image forming apparatus 1 of this embodiment. FIG. 3A is a plan view of the polygon mirror 21, and FIG. 3B is a side view thereof. FIG. 3C is a diagram showing an exemplary inclination angle of each side of the polygon mirror 21.

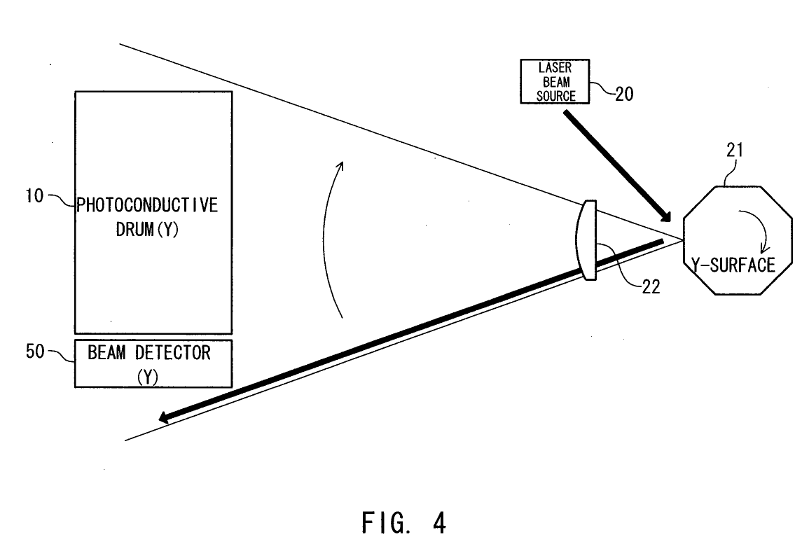

FIG. 4 is a diagram showing scanning of the photoconductive drums 10 by the polygon mirror 21 in the main scanning direction with a laser beam. FIG. 4 shows the scanning range in the main scanning direction by developing reflection in the horizontal direction by the primary mirror 23a and the second mirror 23b.

As shown in FIG. 3A, the polygon mirror 21 of this embodiment has a polygon shape being a multiple of the number of colors. In this embodiment, the polygon mirror 21 has an octagon shape being a multiple of four colors.

The surfaces corresponding to the sides of the octagon respectively correspond to the colors of Y, M, C, and K, and as shown in FIG. 3C, the surfaces are inclined at four elevation angles varying with the colors. In FIG. 3C example, the surfaces are so inclined that the elevation angle of Y becomes the largest, and the surfaces are so inclined that the elevation angles of M, C, and K become smaller in this order. The elevation angles of the Y-surface and M-surface each take a positive value, and the elevation angles of the C-surface and K-surface each take a negative value.

A light reflected by one of the surfaces of the polygon mirror 21 is with an elevation angle varying with the colors, and is used for scanning of the corresponding photoconductive drum 10 in the main scanning direction (horizontal direction) by the rotation of the polygon mirror 21. For example, with the Y-surface of the polygon mirror 21, the laser beam is reflected by the polygon mirror 21 with the largest positive elevation angle, and then reaches the light exposure position of the Y-use photoconductive drum 10 after going through the primary mirror 23a, the secondary mirror 23b, and the cylindrical lens 24. By the rotation of the polygon mirror 21, the photoconductive drum 10 is horizontally scanned in the main scanning direction.

When the reflection surface of the polygon mirror 21 is changed from the Y-surface to the M-surface, the laser beam is reflected at the elevation angle smaller than the Y-use elevation angle, and then reaches the M-use photoconductive drum 10 after going through the optical path different from the Y-use optical path. By the rotation of the polygon mirror 21, the laser beam then scans the M-use photoconductive drum 10 in the main scanning direction.

When the reflection surface of the polygon mirror 21 is changed to the C-surface or to the K-surface, similarly, the laser beam is reflected at each different elevation angle, and reaches the C-use or K-use photoconductive drum 10 after going through each different optical path. The C-use and K-use photoconductive drums 10 are then sequentially scanned in the main scanning direction.

By the polygon mirror 21 rotating a half turn, the photoconductive drums 10 of Y, M, C, and K can be scanned by a line in the main scanning direction. When the polygon mirror 21 rotates a turn, the photoconductive drums 10 of Y, M, C, and K are to be scanned by two lines in the main scanning direction.

With previous typical electrophotography in a tandem system, the four photoconductive drums are each subjected to a light exposure process using four laser beam sources and four polygon mirrors respectively corresponding to the colors of Y, M, C, and K.

On the other hand, with the image forming apparatus 1 in the first embodiment of the invention, the four photoconductive drums 10 disposed at different positions are each subjected to a light exposure process by a single piece of laser beam source 20 and a single piece of polygon mirror 21. Accordingly, the hardware related to the light exposure process can be considerably reduced in size, and the cost can be also reduced. Moreover, with such a reduction of the hardware size, the apparatus can be also reduced in size.

### 2. Color-Based Image Quality Parameter

On the other hand, pursuing the reduction of apparatus size with a single piece of laser beam source and a single piece of polygon mirror (shared in use) results in a slight difficulty, compared with a previous technique, in ensuring the uniformity of the color-based characteristics (image quality parameter) that are supposed to be uniform.

To be specific, because the optical paths from the laser beam source 20 vary with the colors, it is difficult to ensure the length uniformity among the optical paths varying with the colors as such. When the optical paths vary in length with the colors, a difference occurs in the scanning distance of the photoconductive drums in the main scanning direction, thereby resulting in variations, with the colors, of an image magnification (first image quality parameter) in the main scanning direction.

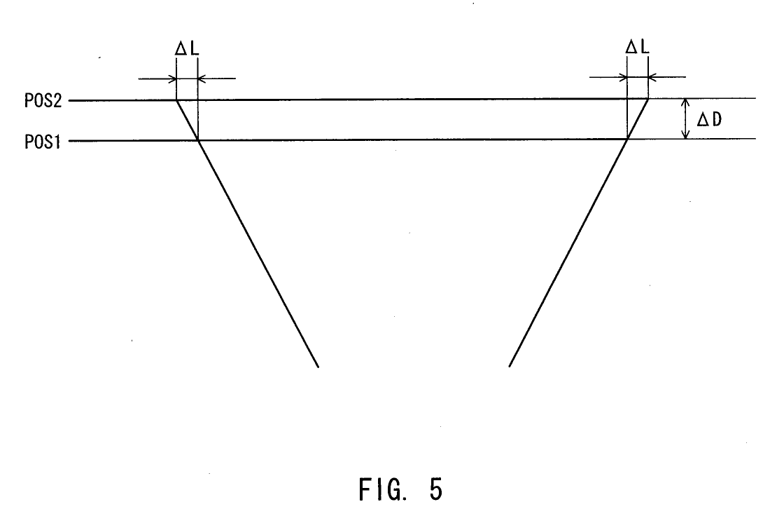

FIG. 5 is a schematic diagram describing this. Assuming here is that the surface of a photoconductive drum A of a specific color is located at the position of POS1, and the surface of a photoconductive drum B of another color is located at the position of POS2. The distance difference ΔD between POS1 and POS2 is equivalent to the difference of the optical path lengths from the laser beam source. In this case, the range of a scanning angle with respect to the photoconductive drum A in the main scanning direction is the same as the range of the scanning angle with respect to the photoconductive drum B in the main scanning direction. Therefore, the photoconductive drum B located at the position of POS2 will have an image larger in size by 2ΔL as shown in FIG. 5. That is, even for any one specific image, the photoconductive drum B shows a higher image magnification than the photoconductive drum A. As a result, when two colors are overlaid one on the other, a color drift is caused, thereby reducing the image quality.

Even with a configuration of including a single piece of laser beam source 20 and a single piece of polygon mirror 21, it is indeed theoretically possible to ensure the uniformity of the optical path lengths varying with the colors by design ideas in terms of the number and the placement of the primary mirrors 23a and the secondary mirrors 23b, and by adjusting the positions thereof with good precision. However, if the number and the placement of the primary mirrors 23a and the secondary mirrors 23b are determined with a priority given to the uniformity of the optical path lengths, this may lead to a result contrary to apparatus downsizing. Furthermore, if the placement positions are to be adjusted with good precision, the time needed for such adjustment takes long, thereby increasing the apparatus cost.

In consideration thereof, the image forming apparatus 1 of this embodiment is adopting a method of preventing occurrence of a color drift by adjusting an image magnification on a color basis at the drive source of the laser beam source 20. The specific method will be described below.

The color drift is caused not only by variations of an image magnification but also by variations, with the colors, of an image writing position (second image quality parameter) on each of the photoconductive drums 10 in the main scanning direction.

Generally, the image writing position on the photoconductive drum in the main scanning direction is determined based on a horizontal synchronizing pulse (or Beam Detected pulse). As shown in FIG. 4, on the upstream side of the photoconductive drums for main scanning, a beam detector is disposed adjacent to each of the photoconductive drums. When a laser beam passes through the beam detector, a horizontal synchronizing pulse is output from the beam detector, and after the lapse of a predetermined delay time from the horizontal synchronizing pulse, image data is written out to the corresponding photoconductive drum.

With an image forming apparatus of a tandem type, the four beam detectors of the colors are disposed respectively adjacent to the photoconductive drums of the colors. When the space between the beam detector and the photoconductive drum varies with the colors due to an attachment error or others, if any same delay time is used as a basis to determine the image writing position in the main scanning direction, it results in image writing from positions varying with the colors. As a result, a color drift occurs.

Other than this, with the optical paths varying with the colors, a light attenuation amount on the optical path (third image quality parameter) also varies with the colors in the strict sense. Optical devices such as a mirror and a cylindrical lens on the optical path are provided separately to every optical path, and individual variations among these optical devices in terms of light reflection factor and transmittance vary, with the colors, the light attenuation amount on the optical paths. Therefore, even if a laser beam comes from a single piece of laser beam source 20, the photoconductive drums 10 have each different light-receiving level on their surfaces. As a result, when the colors are overlaid one on the other, the color looks different from the color that is originally expected, thereby reducing the color reproducibility.

On the stage subsequent to the polygon mirror 21, the f-θ lens 22 is disposed. The distribution of the transmittance of the f-θ lens 22 in the main scanning direction shows no uniformity with respect to the main scanning direction. The longer the distance from the center of the f-θ lens 22, the lower the transmittance will be. For correcting such non-uniformity of the transmittance as such, a widely-used process is of changing the power of a laser beam in the main scanning direction, and making uniform the amount of light after the passage through the f-θ lens. In the image forming apparatus 1 of the first embodiment, this f-θ lens 22 is provided also only a piece, thereby aiming sharing use of components as are the laser beam source 20 and the polygon mirror 21. The issue here is that, because a laser beam coming from the polygon mirror 21 has an elevation angle varying with the colors, the incident angle of the f-θ lens 22 in the direction of an elevation angle also varies with the colors. As a result, the distribution of the transmittance (fourth image quality parameter) of the f-θ lens 22 with respect to the main scanning direction also varies with the colors in the strict sense, thereby resultantly reducing the color reproducibility.

As described in the foregoing, when the image quality parameters vary with the colors, e.g., image writing position in the main scanning direction, the light attenuation amount on the optical path, and the distribution of the transmittance in the main scanning direction, these may cause deterioration of the image quality, e.g., color drift and reduction of color reproducibility.

In consideration thereof, the image forming apparatus 1 of this embodiment is provided with a unit in charge not only of adjusting the above-described image magnification but also of adjusting these image quality parameters on a color basis. To be specific, a laser beam source control unit and an adjustment data control unit that will be described next take charge of adjusting the image quality parameters on a color basis.

### 3. Laser Beam Source Control Unit and Adjustment Data Control Unit

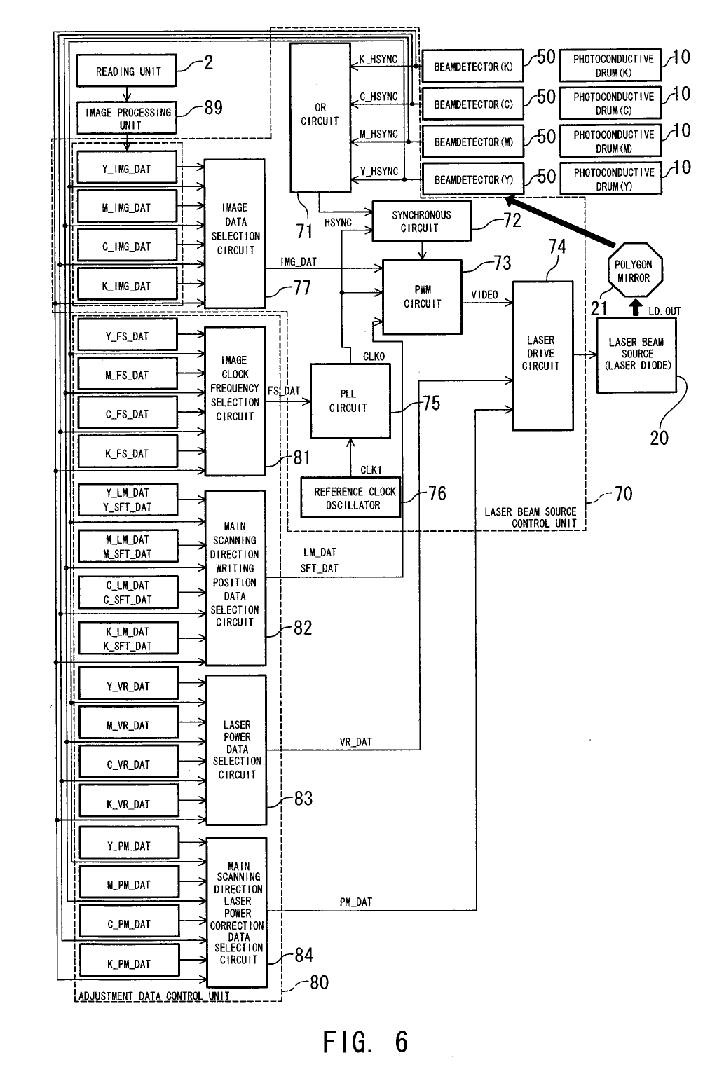

FIG. 6 is a block diagram mainly showing an exemplary detailed configuration of a laser beam source control unit 70 and that of an adjustment data control unit 80. The laser beam source control unit 70 and the adjustment data control unit 80 are included in a control unit 40 (refer to FIG. 2). Note that the control unit 40 also includes an image processing unit 89, and controls also over the image forming apparatus 1 in its entirety.

The laser beam source control unit 70 is configured to include an OR circuit 71, a synchronous circuit 72, a PWM circuit 73, a laser drive circuit 74, a PLL circuit 75, a reference clock oscillator 76, an image data selection circuit 77, and others.

The adjustment data control unit 80 is configured to include a reference clock frequency selection circuit 81, a main scanning direction writing position data selection circuit 82, a laser power data selection circuit 83, a main scanning direction laser power correction data selection circuit 84, and others. Other than these, a memory (not shown) is also provided for storage of various types of adjustment data.

Described first is the operation of the laser beam source control unit 70.

A laser beam emitted from the laser beam source 20 is reflected by the polygon mirror 21, and reaches the photoconductive drums 10 of colors respectively associated with the reflection surfaces for scanning of the photoconductive drums 10 in the main scanning direction. Every time when a surface change occurs due to the rotation of the polygon mirror 21, the photoconductive drum 10 to be exposed with the light beam is changed in a sequential manner.

On the upstream side of each of the photoconductive drums 10, a beam detector 50 is adjacently disposed. Before scanning of the photoconductive drums 10 is started in the main scanning direction, the beam detectors 50 respectively output, sequentially, horizontal synchronizing pulses (Y_HSYNC, M_HSYNC, C_HSYNC, and K_HSYNC) of the colors.

These horizontal synchronizing pulses (Y_HSYNC, M_HSYNC, C_HSYNC, and K_HSYNC) are input into the selection circuits 77, 81, 82, 83, and 84 as selection signals, and become horizontal synchronizing pulses HSYNC with OR established in the OR circuit 71.

On the other hand, the image data selection circuit 77 is provided with, from the image processing unit 89, image data through with image processing on a color basis (Y_IMG_DAT, M_IMG_DAT, C_IMG_DAT, and K_IMG_DAT). The image data selection circuit 77 selects, using the horizontal synchronizing pulses of colors as selection signals, image data of any corresponding color, and forwards the result as image data IMG_DAT to the PWM circuit 73. When Y_HSYNC is provided as the horizontal synchronizing pulse of a color, for example, Y_IMG_DAT is selected for output to the PWM circuit 73. When M_HSYNC is provided next, M_HSYNC is selected for output to the PWM circuit 73.

On the other hand, with the PLL circuit 75, a reference clock coming from the reference clock oscillator 76 is used as a basis to generate an image clock with a cycle of a unit of a pixel. This image clock is output to the PWM circuit 73 after synchronization is established with the horizontal synchronizing pulse HSYNC in the synchronous circuit 72.

The PWM circuit 73 generates a modulated video signal VIDEO that has been through with pulse width modulation in accordance with the level of the image data IMG_DAT of a unit of a pixel. The resulting video signal is output to the laser drive circuit 74 in synchronization with the image clock.

The modulated video signal VIDEO is converted into a driving current through with pulse width modulation in the laser drive circuit 74, thereby driving a laser diode.

In a period of reflection by the Y-surface of the polygon mirror 21, first of all, the horizontal synchronizing pulse Y_HSYNC comes from the beam detector 50 for use of yellow, and by this signal, the image data Y_IMG_DAT is selected for use of yellow. Thereafter, by the laser beam through with pulse width modulation by the image data Y_IMG_DAT, the photoconductive drum 10 for use of yellow is subjected to scanning in the main scanning direction. Thereafter, when the reflection surface of the polygon mirror 21 is changed from the Y-surface to the M-surface, the horizontal synchronizing pulse M_HSYNC is output first from the beam detector 50 for use of magenta, and by this signal, the image data M_IMG_DAT for use of magenta is selected. Thereafter, by the laser beam through with pulse width modulation by the image data M_IMG_DAT, the photoconductive drum 10 for use of magenta is subjected to scanning in the main scanning direction. After that, similarly, the photoconductive drum 10 for use of cyan and the photoconductive drum 10 for use of black are both subjected to scanning in the main scanning direction, and when the polygon mirror 21 rotates a half turn, the photoconductive drums 10 of the colors are each formed with an electrostatic latent image by a line. By repeating such a process in association with the rotation operation of the photoconductive drums 10, the photoconductive drums 10 are each formed thereon with an electrostatic image based on the image data of the corresponding color.

### 4. Color-Based Image Magnification Adjustment

As described above, the image forming apparatus 1 of this embodiment adjusts any variations of an image magnification in the main scanning direction caused by varying optical path lengths with the colors, thereby making the same the image magnification among the colors. To be specific, the frequency of an image clock is adjusted on a color basis so that the image magnification is adjusted.

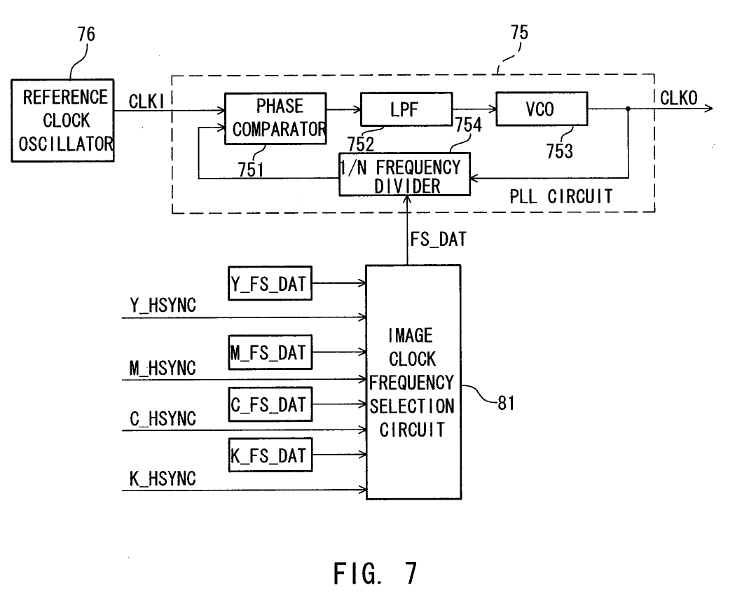

FIG. 7 is a diagram for illustrating the mechanism of frequency adjustment of image clocks. The PLL circuit 75 generating an image clock is configured to include a phase comparator 751, an LPF (Low-Pass Filter) 752, a VCO (Voltage Controlled Oscillator) 753, and a 1/N frequency divider 754.

The VCO 753 generating an image clock controls the frequency of an image clock using a phase-locked loop in such a manner that the 1/N frequency of the image clock frequency becomes the same as the frequency of a reference clock. Such a PLL circuit 75 generates an image clock of a frequency being a result of multiplying, by N, the frequency of the reference clock.

The higher frequency of an image clock, the smaller the pixel size becomes. On the other hand, the lower frequency of an image clock, the larger the pixel size will be. As such, by adjusting the frequency of an image clock on a color basis, the image magnification can be so adjusted as to be the same among the colors.

As shown in FIGS. 6 and 7, the image clock frequency selection circuit 81 selects, for each of the colors, the image clock frequency data (Y_FS_DAT, M_FS_DAT, C_FS_DAT, and K_FS_DAT) based on the horizontal synchronizing pulses (Y_HSYNC, M_HSYNC, C_HSYNC, and K_HSYNC) of the colors, and forwards the result to the 1/N frequency divider 754 of the PLL circuit 75.

Note here that the image clock frequency data of the colors (Y_FS_DAT, M_FS_DAT, C_FS_DAT, and K_FS_DAT) is data corresponding to the multiplication number N, which is determined in advance to make the same the image magnification among the colors. The data is stored in any appropriate memory.

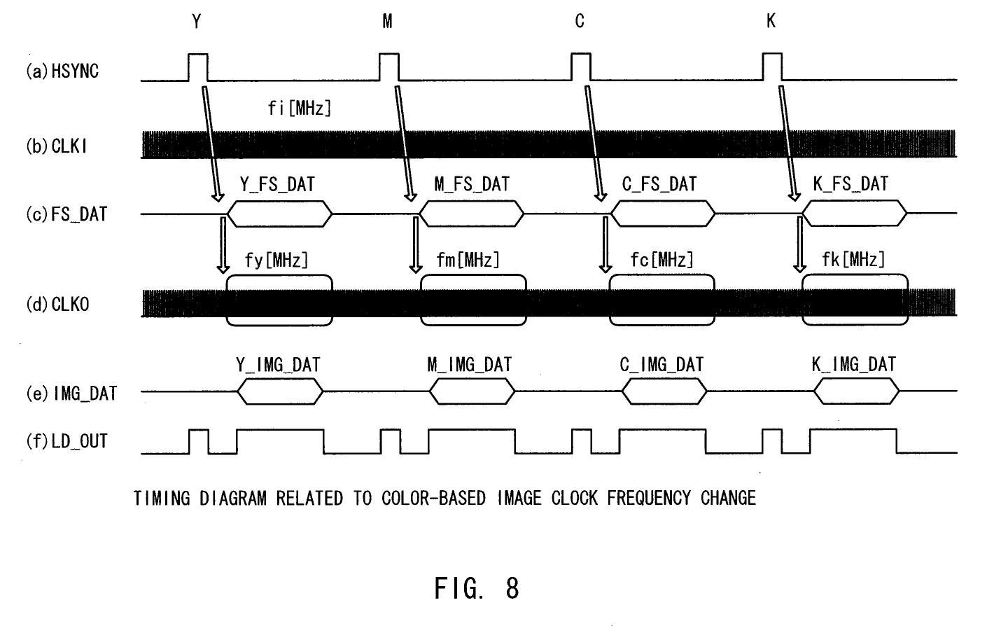

FIG. 8 is a timing diagram related to an image clock frequency switching process. In this embodiment, a color is switched on the basis of a reflection surface of the polygon mirror 21, and a horizontal synchronizing pulse (Y_HSYNC, M_HSYNC, C_HSYNC, or K_HSYNC) is sequentially output depending on which color (FIG. 8(a)). By these horizontal synchronizing pulses, the image clock frequency data (Y_FS_DAT, M_FS_DAT, C_FS_DAT, and K_FS_DAT) of the colors is sequentially selected (FIG. 8(c)). Based on the selected image clock frequency data, the frequency (fy, fm, fc, and fk) of the image clock is changed on a color basis (FIG. 8(d)). In synchronization with the image clock switched as such, the image data (Y_IMG_DAT, M_IMG_DAT, C_IMG_DAT, and K_IMG_DAT) of the colors is forwarded to the PWM circuit 73 (FIG. 8(e)), and the result serves as a laser beam (LD_OUT) coming from the laser beam source 20.

As such, with the image forming apparatus 1 in this embodiment, the image clock frequency data (Y_FS_DAT, M_FS_DAT, C_FS_DAT, and K_FS_DAT) of the colors switched on the basis of a reflection surface of the polygon mirror 21 is used as a basis to switch the frequency of an image clock, thereby eliminating any possible variations of an image magnification that is often caused by varying optical path lengths with the colors. As such, the resulting color image can be free from a color drift.

### 5. Color-Based Adjustment of Main Scanning Direction Writing Position

As described above, when the space between the beam detector 50 and the photoconductive drum 10 varies with the colors, the main scanning direction writing position also varies with the colors.

For correcting such variations, the output start timing may be adjusted on a color basis for the modulated video signal VIDEO in the PWM circuit 73.

To be specific, a delay amount from each of the horizontal synchronizing pulses to the image writing position may be set on a color basis, and based on the delay amount set on a color basis as such, the output timing may be determined for the modulated video signal VIDEO.

In the PWM circuit 73 of this embodiment, the delay amount can be adjusted both by a unit of a pixel and by a unit of a pixel or smaller. The data of the former delay amount is referred to as LM_DAT, and the data of the latter delay amount is as SFT_DAT. In relation thereto, the data of a delay amount of each of the colors is referred to as (Y_LM_DAT, Y_SFT_DAT), (M_LM_DAT, M_SFT_DAT) (C_LM_DAT, C_SFT_DAT) and (K_LM_DAT, K_SFT_DAT).

As shown in FIG. 6, in the main scanning direction writing position data selection circuit 82, from the delay amounts of the colors as such, a selection is made using the horizontal synchronizing pulses for the colors (Y_HSYNC, M_HSYNC, C_HSYNC, and K_HSYNC), and the selection result is output to the PWM circuit 73. In the PWM circuit 73, because the delay amounts for the colors are used as a basis to adjust the output timing for the modulated video signal VIDEO, in each of the photoconductive drums 10, image data is written out from the same position no matter which color.

### 6. Color-Based Adjustment of Laser Power, and Adjustment of Main Scanning Direction Laser Power Correction Data

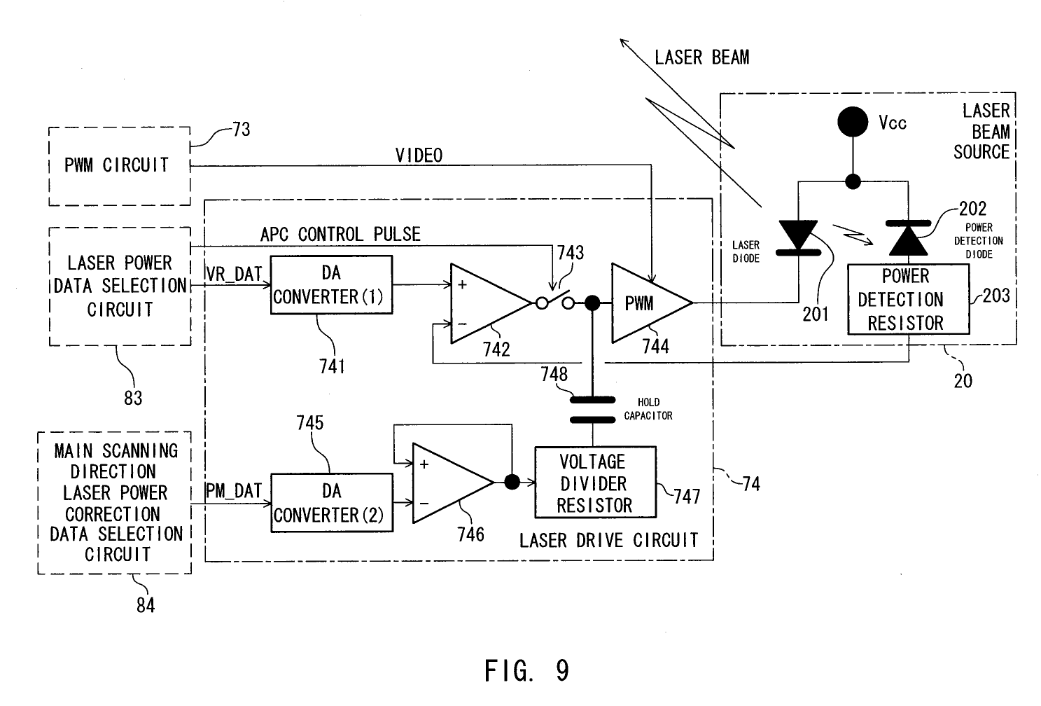

FIG. 9 is a diagram showing an exemplary detailed configuration of the laser beam source 20 and that of the laser drive circuit 74.

The laser beam source 20 includes therein a laser diode 201, a power detection diode 202, and a power detection resistor 203. The laser diode 201 emits a light in response to a driving current coming from the laser drive circuit 74, and outputs the laser beam toward the polygon mirror 21. The power of the laser beams is detected by the power detection diode 202 and the power detection resistor 203 as a voltage value, and the resulting power-detected voltage value is fed back to the laser drive circuit 74.

The laser drive circuit 74 is configured to include a DA converter (1) 741, a differential amplifier 742, a switch 743, a PWM/driver 744, a DA converter (2) 745, a buffer amplifier 746, a voltage divider resistor 747, a hold capacitor 748, and others.

The PWM/driver 744 turns on and off an input voltage in response to a modulated video signal VIDEO being a result of pulse width modulation at the amplitude level of a pixel, and performs a conversion into a driving current so that the laser diode 201 is driven.

The peak value of the laser beam through with pulse width modulation, i.e., laser power, is defined by the input voltage of the PWM/driver 744. This input voltage is so controlled by an APC (Auto Power Control) operation that the output laser power from the laser diode 201 becomes the same as any desired value of a reference laser power.

The laser power data VR_DAT coming from the laser power data selection circuit 83 is equivalent to the above-described value of the reference laser power. The differential amplifier 742 operates in such a manner that a voltage value VR being a result of DA conversion of the laser power data VR_DAT by the DA converter (1) 741 becomes the same as the power-detected voltage value to be fed back from the laser beam source 20 so that the APC operation is performed.

The APC operation is performed in a period when an APC control pulse is being turned on. In the period when the APC control pulse is being turned on, the switch 743 is closed, and the charge voltage of the hold capacitor 744, i.e., the input voltage of the PWM/driver 744 is changed. When the output laser power of the laser diode 201 reaches any desired value of the reference laser power, settling is made.

In a period when the APC Control pulse is being turned off, the switch 743 is open, and the voltage (APC voltage) of the hold capacitor 744 is retained. In this state, the photoconductive drums 10 are subjected to scanning in the main scanning direction. As such, in the period of scanning in the main scanning direction, a laser beam is output with a peak power matching the desired reference laser power defined by the APC operation.

With the laser drive circuit 74 of this embodiment, the laser power correction is also made in the main scanning direction. As described in the foregoing, the distribution of the transmittance of the f-θ lens 22 in the main scanning direction is not uniform in the main scanning direction, and the longer distance from the center of the f-θ lens 22, the lower the transmittance will be. In consideration thereof, the laser power of the laser diode 201 is changed in the main scanning direction in such a manner as to derive the distribution of the transmittance opposite in direction to the distribution of the transmittance of the f-θ lens 22 in the main scanning direction. The laser power being the output from the f-θ lens 22 is so made as to be uniform not dependent on the main scanning angle.

The laser power correction data PM_DAT in the main scanning direction is output from the main scanning direction laser power correction data selection circuit 84, and is subjected to DA conversion by the DA converter (2) 745. The voltage as a result of DA conversion (main scanning direction laser power corrected voltage PM) is applied to one terminal of the hold capacitor 748 via the buffer amplifier 746 and the voltage divider resistor 747.

In a period of scanning in the main scanning direction, the APC operation is completed, and the APC voltage retained in the hold capacitor 748 is added together with the main scanning direction laser power corrected voltage being a result of pressure partition. The addition result is applied to the input of the PWM/driver 744.

The image forming apparatus 1 in this embodiment is so configured as to be able to adjust, on a color basis, the laser power data VR_DAT corresponding to the value of the reference laser power of the APC operation and the laser power correction data PM_DAT in the main scanning direction.

As shown in FIG. 6, in the laser power data selection circuit 83, the laser power data Y_VR_DAT, M_VR_DAT, C_VR_DAT, and K_VR_DAT of the colors corresponding to Y, M, C, and K is selected by the horizontal synchronizing pulses of the colors (Y_HSYNC, M_HSYNC, C_HSYNC, and K_HSYNC), and the selection results are output to the laser drive circuit 74. In the laser drive circuit 74, the APC is performed based on the laser power data of the colors. As such, if the attenuation amount is known in advance for the optical paths of the colors, the laser power data is so set as to correct the variations of this attenuation amount, thereby being able to make uniform the light-receiving level on the surfaces of the photoconductive drums 10. The laser power data Y_VR_DAT, M_VR_DAT, C_VR_DAT, and K_VR_DAT of the colors may be stored in any appropriate memory based on data of the attenuation amounts acquired in advance.

Alternatively, in a period other than any normal image printing period, the printing operation may be performed for a test pattern, and may acquire data of the laser powers for each of the colors. The test pattern of the colors transferred onto a transfer belt may be subjected to a detection of color density using a sensor, and the data of the laser powers is set for each of the color so as to make uniform the detected color densities. This method is capable of correcting not only any variations of an optical attenuation amount on an optical path but also any color-to-color variations of attenuation amount in a broad sense including the sensitivity and the developing characteristics of each of the photoconductive drums 10. Moreover, by performing the printing operation of a test pattern at any appropriate intervals, and by updating the color-to-color data of laser power for every printing operation, the method is able to correct also color-to-color variations of the attenuation amount, in a broad sense, caused by environmental change such as temperature and humidity change or any change with time.

Moreover, as shown in FIG. 6, in the main scanning direction laser power correction data selection circuit 84, the main scanning direction laser power correction data Y_PM_DAT, M_PM_DAT, C_PM_DAT, and K_PM_DAT of the colors corresponding to Y, M, C, and K is selected by the horizontal synchronizing pulses of the colors (Y_HSYNC, M_HSYNC, C_HSYNC, and K_HSYNC), and the selection results are output to the laser drive circuit 74. In the laser drive circuit 74, the main scanning direction laser power correction data of the colors is used as a basis to cause a change in the main scanning direction, and in the output of the f-θ lens 22, the distribution of the transmittance becomes substantially uniform no matter which color.

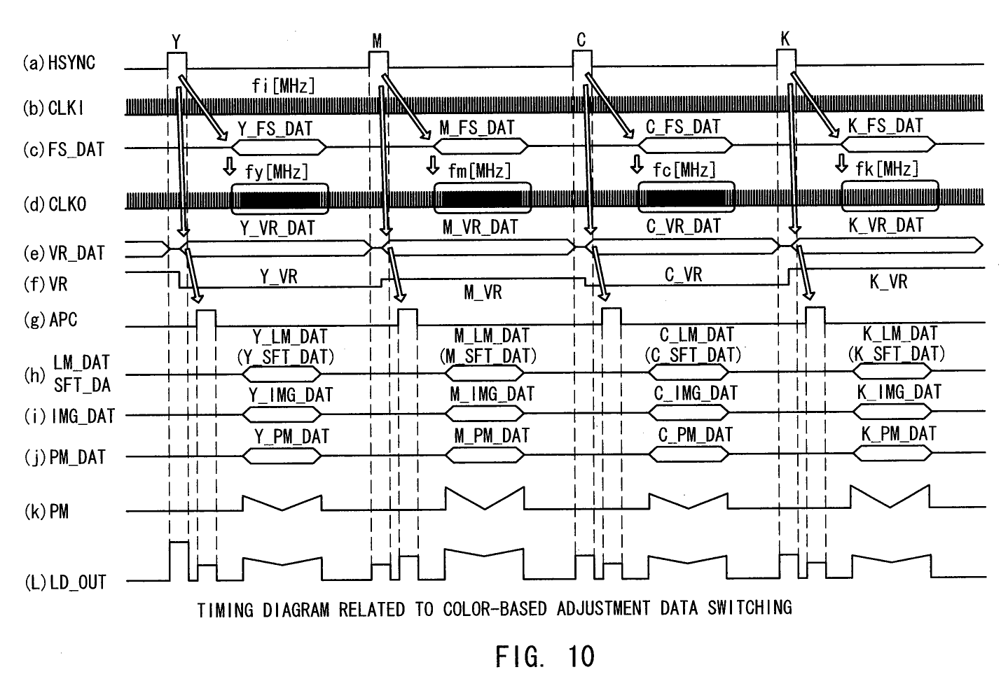

FIG. 10 is a timing diagram related to color-based switching of adjustment data including color-based adjustment of laser power and correction of laser power in the main scanning direction.

The laser power data VR_DAT is selected on a color basis by the horizontal synchronizing pulse HSYNC (FIG. 10(e)), and serves as a reference laser power voltage VR as a result of DA conversion (FIG. 10(f)). Thereafter, in a period when the APC control pulse (FIG. 10(g)) coming immediately after the horizontal synchronizing pulse HSYNC is being turned on, the APC operation is performed. After the APC operation is completed, the reference laser power voltage VR is retained during a scanning period of any corresponding color, and when a change of reflection surface is observed in the polygon mirror 21, the voltage is changed to the next reference laser power voltage VR of the next color.

Similarly, the main scanning direction laser power correction data PM_DAT is also selected by the horizontal synchronizing pulse HSYNC on a color basis (FIG. 10(j)), and the result serves as the main scanning direction laser power corrected voltage PM through with DA conversion (FIG. 10(k)).

The laser power based on the reference laser power voltage VR is added together with the laser power based on the main scanning direction laser power corrected voltage PM, and the result serves as the laser power LD_OUT coming from the laser diode 201 (FIG. 10(l)).

### 7. First Modified Example of First Embodiment

In the first embodiment described above, after the horizontal synchronizing pulse HSYNC of a color is output, the APC operation is performed before image formation is started on the photoconductive drum 10 for the color (refer to FIG. 10(g)). That is, at the position in the middle between any one of the beam detectors 50 and the image forming area of the photoconductive drum 10 adjacent thereto, the APC operation is performed. Generally, with the APC operation, a laser beam of high intensity is emitted. As such, a laser beam for the APC operation may be leaked into the image forming area, thereby possibly causing adverse influence on images.

For solving such a problem, in the first modified example, the APC operation is performed after the lapse of a predetermined allowance time after image formation on the photoconductive drum 10 of a specific color is completed but before the horizontal synchronizing pulse HSYNC for the next color comes. In such a first modified example, the APC operation is performed at a position away from the image forming area of the photoconductive drum 10. Accordingly, the laser beam for the APC operation does not leak into the image forming area, thereby causing no adverse influence on images.

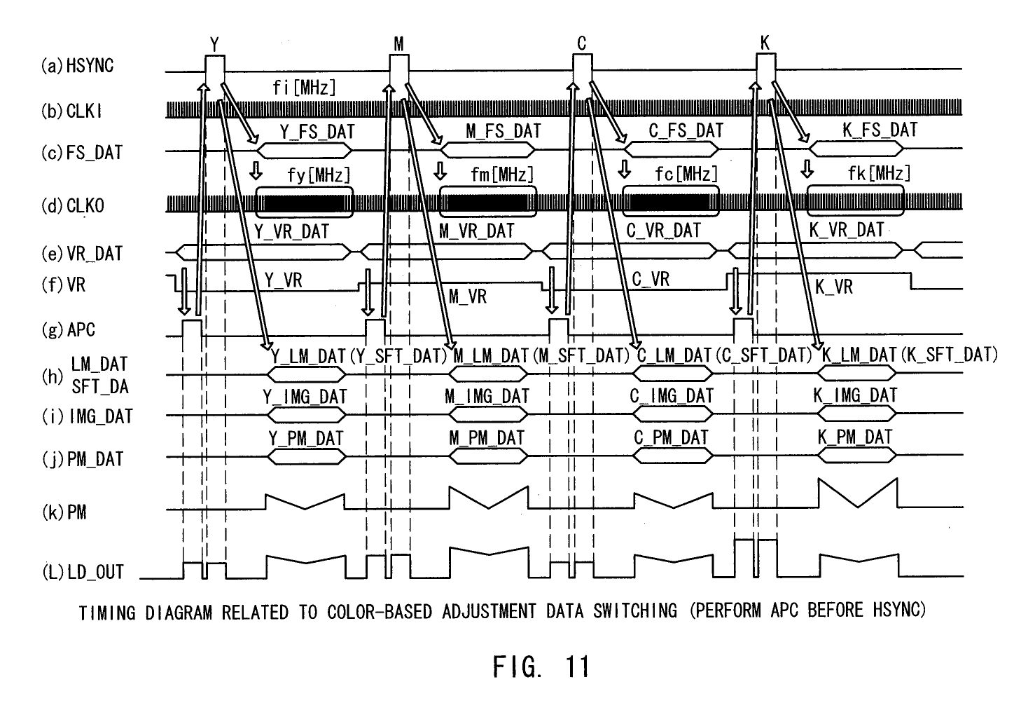

FIG. 11 is a timing diagram in the first modified example, and shows that an APC control pulse (FIG. 11(g)) is output immediately before a horizontal synchronizing pulse HSYNC.

In the first modified example, as shown in FIGS. 11(e) and 11(f), after a horizontal synchronizing pulse HSYNC of a preceding color (e.g., Y) is input, the timing with the lapse of a predetermined allowance time after image formation of the color (Y) is found by any appropriate counter, for example. The laser power data M_VR_DAT of the next color (M) is then forwarded to the laser drive circuit 74. Immediately thereafter, the APC operation is performed.

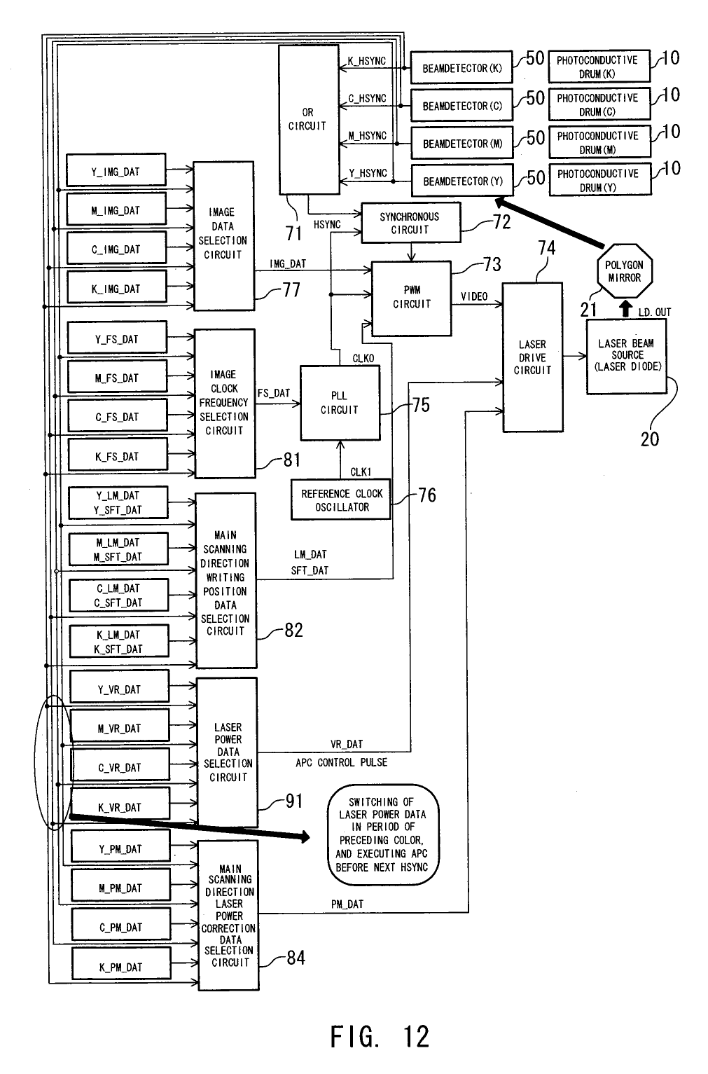

To enable such a switching, with the laser power data selection circuit 91 in the first modified example, as shown in FIG. 12, the laser power data Y_VR_DAT, M_VR_DAT, C_VR_DAT, and K_VR_DAT of the colors is selected by a horizontal synchronizing pulse HSYNC of a color shifted by one.

### 8. Second Modified Example of First Embodiment

In the image forming apparatus 1 of the first embodiment, an image clock is generated in the PLL circuit 75 using a phase-locked loop. The phase-locked loop generally requires a settling time of some length until the frequency is stabilized after the setting of an output frequency. If a process is started for an effective image area before settling of the image clock frequency of each of the colors, a pixel size change is observed in the main scanning direction, thereby resulting in deterioration of the image quality.

As described above, in this embodiment, the output frequency (image clock frequency) is switched on a color basis in response to a change of the reflection surface of the polygon mirror 21. To be specific, the horizontal synchronizing pulses (Y_HSYNC, M_HSYNC, C_HSYNC, and K_HSYNC) of the colors are used as a basis to select the image clock frequency data of the colors (Y_FS_DAT, M_FS_DAT, C_FS_DAT, and K_FS_DAT), and the selection results are output to the PLL circuit 75. In the PLL circuit 75, upon reception of the selected image clock frequency data FS_DAT, an operation of frequency switching is immediately started, but a predetermined settling time is required until the frequency is settled.

In consideration thereof, in a second modified example, the distance L from any of the beam detectors 50 outputting a horizontal synchronizing pulse to the photoconductive drum 10 adjacent thereto is increased to some degree, thereby ensuring the settling time.

To be specific, the beam detector 50 is disposed at a position where Li>V·T is established, where L1 denotes the distance between the beam detector 50 and an upstream end portion of the image forming area (effective image area) of the corresponding photoconductive drum 10, V denotes the scanning speed on the photoconductive drum 10 in the main scanning direction, and T denotes the settling time of the phase-locked loop.

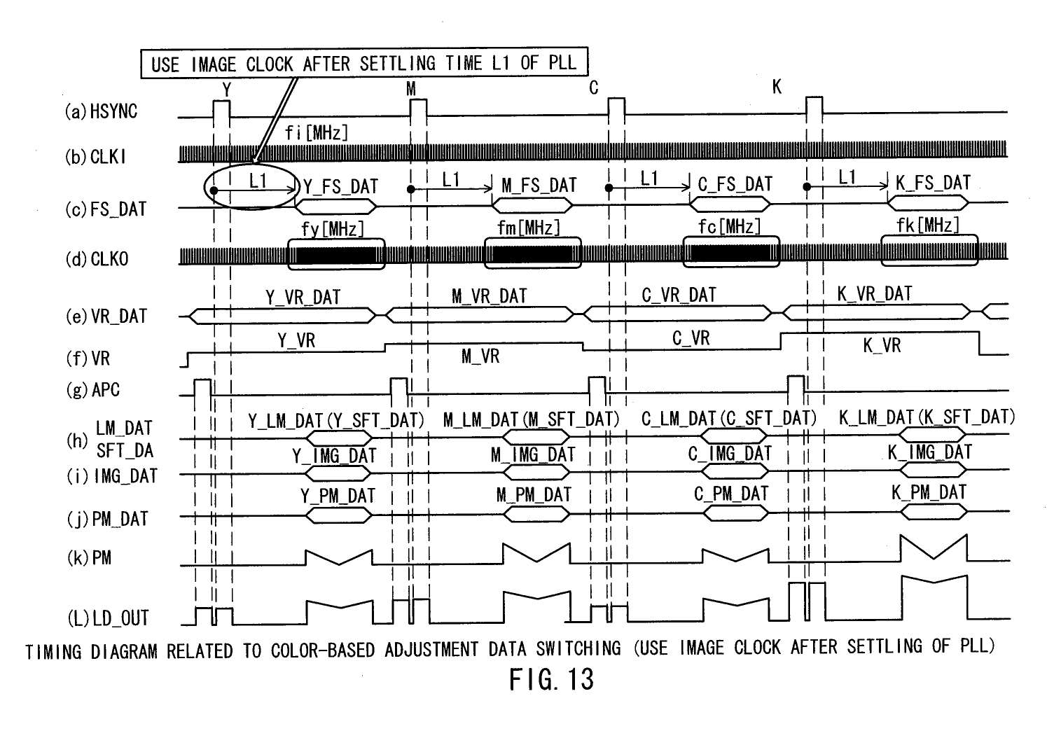

FIG. 13 is a timing diagram related to the second modified example. After a horizontal synchronizing pulse HSYNC is output from the beam detector 50, the phase-locked loop is settled by the time when a laser beam reaches the distance L1 up to the effective image area, and it is thus known that the image formation is possible with a stable frequency (FIG. 13(c)).

### 9. Third Modified Example of First Embodiment

In the second modified example, the distance between the beam detector 50 and the photoconductive drum 10 is set to a relatively large value so that the settling time is ensured for the phase-locked loop. The concern with this method is that the physical apparatus size may be increased, and the scanning range may be widened in the main scanning direction, thereby imposing limitations on the layout of an optical system.

In consideration thereof, in the third modified example, without increasing the distance between the beam detector 50 and the photoconductive drum 10, the settling time is ensured for a phase-locked loop.

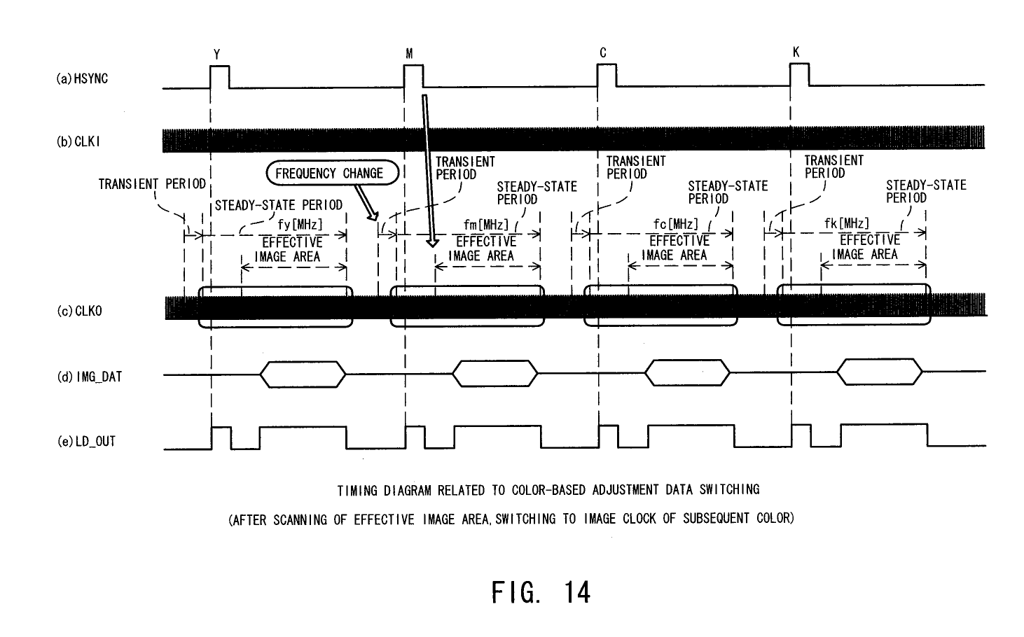

FIG. 14 is a timing diagram related to a third modified example. In the third modified example, as shown in FIG. 14(c), after one of the photoconductive drums 10 (e.g., Y) is through with scanning for its image forming area (effective image area), an operation of pulling the phase-locked loop is started with a switching of an image clock frequency for the next color (M) before the horizontal synchronizing pulse HSYNC for the next color (M) comes. Thereafter, by the time when scanning is started for the image forming area (effective image area) on the photoconductive drum 10 for (M) for the next scanning, the operation of pulling the phase-locked loop is completed to end the setting time (transient period).

To be more specific, after a horizontal synchronizing pulse HSYNC of a preceding color (e.g., Y) is input, the timing for completion of image formation for the color (Y) is found by any appropriate counter, for example, and the image clock frequency data M_FS_DAT for the subsequent color (M) is output to the PLL circuit 75. In the PLL circuit 75, based on the image clock frequency data thus provided, the operation of pulling a phase-locked loop is immediately started.

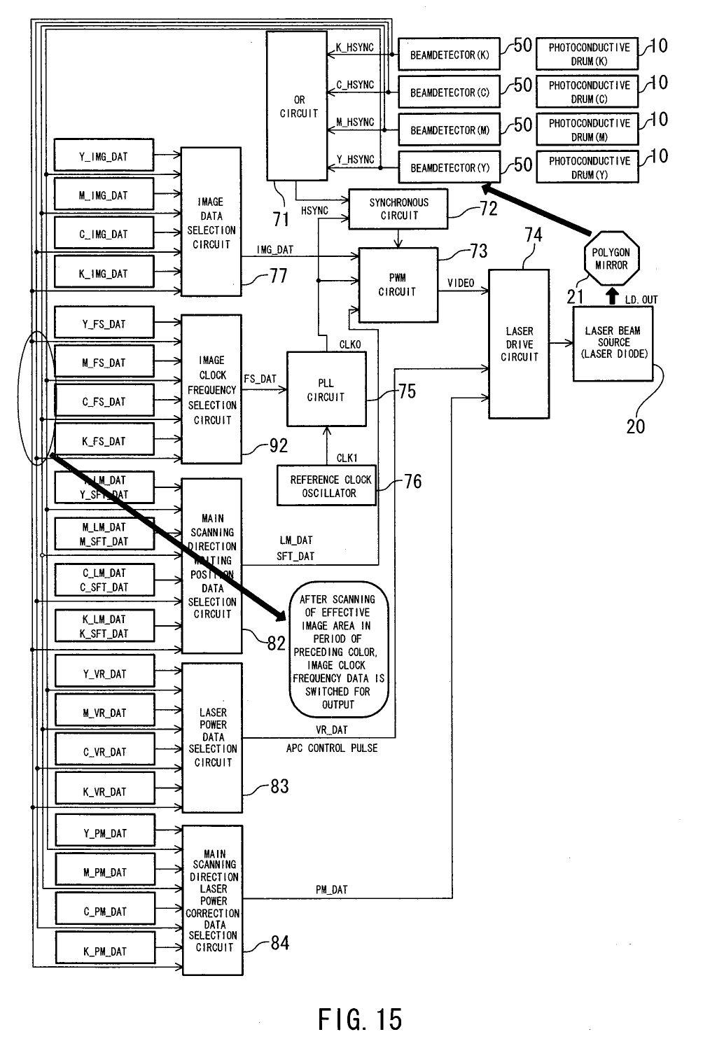

To enable such a switching, in a image clock frequency selection circuit 92 of the third modified example, as shown in FIG. 15, the image clock frequency data Y_FS_DAT, M_FS_DAT, C_FS_DAT, and K_FS_DAT of the colors is selected by the horizontal synchronizing pulse HSYNC of a color shifted by one.

### 10. Second Embodiment

The image forming apparatus 1 of the first embodiment is of a single beam configuration using a single piece of laser beam source 20. On the other hand, a second embodiment is a modified version of the first embodiment, being configured as an image forming apparatus 1a of a multi beam type using a plurality of laser beam sources.

With the multi-beam-type image forming apparatus 1a, a plurality of laser beams allow simultaneous formation of a plurality of lines to the photoconductive drums 10, thereby being able to increase the printing speed and the resolution.

Also in the image forming apparatus 1a of the second embodiment, the polygon mirror 21 is solely provided, and similarly to the first embodiment, an adopted method is of changing a color every time the surface of the polygon mirror 21 is changed.

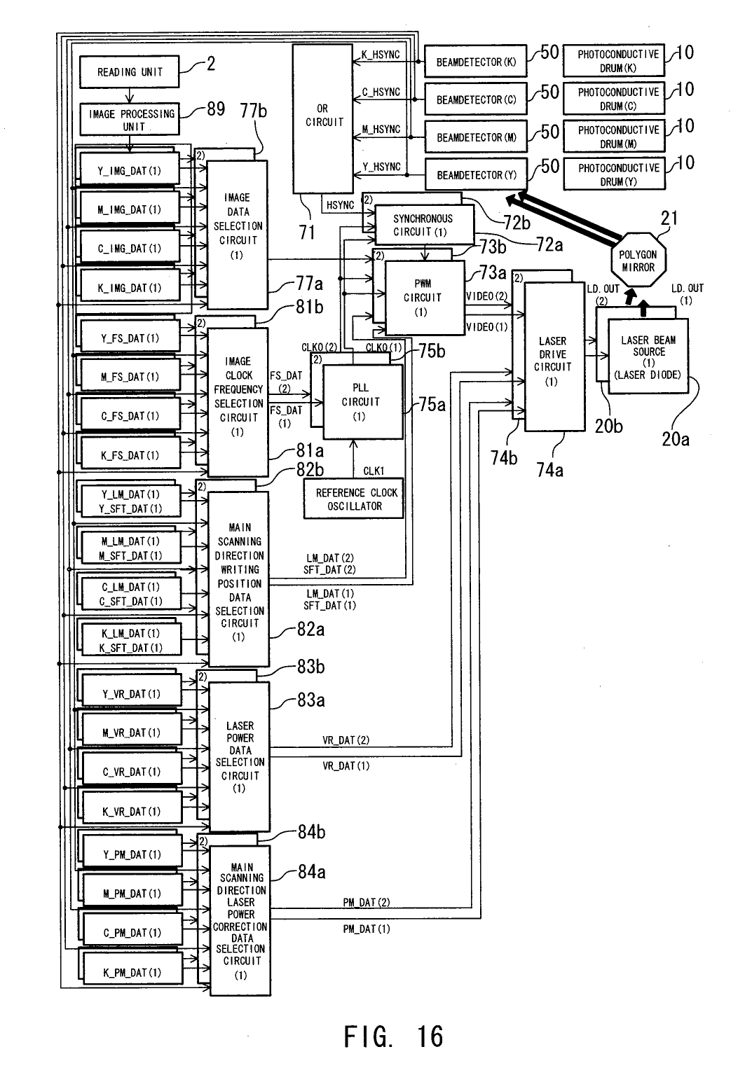

FIG. 16 is a diagram showing an exemplary configuration with a case of two beams. With the configuration example of FIG. 16, the photoconductive drum 10 and the beam detector 50 are each provided on a color basis, and the polygon mirror 21 and the OR circuit 71 are each solely provided. The remaining units (circuits) are provided two of each in accordance with the number of beams. The operation of each of the circuits is the same as that in the first embodiment, and thus is not described again.

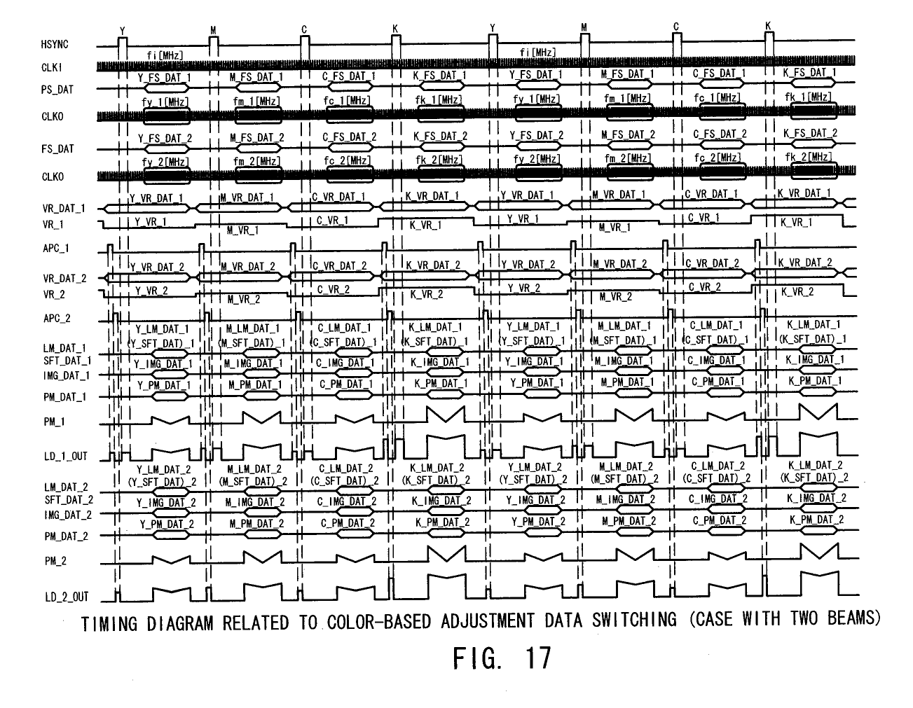

FIG. 17 is a timing diagram related to a switching of adjustment data with the configuration of two beams. In FIG. 17, a signal name related to a first beam is provided with a suffix “1”, and a signal name related to a second beam is provided with a suffix “2”. The basic timing and others are similar to those in the first embodiment, and thus are not described again.

With the image forming apparatus 1a of the second embodiment, the effects similar to those in the first embodiment can be achieved, and the printing speed can be increased, and the image resolution can be increased.

As described above, according to the image forming apparatuses of the above embodiments and those of the modified examples, and the control methods thereof, any variations can be reduced for an image magnification possibly occurred in the main scanning direction depending on which color and any variations can be reduced for a light-receiving level possibly occurred on the photoconductive drums depending on which color, any variations can be reduced for other various image quality parameters, any possible color drift can be eliminated, and the high color reproducibility can be achieved.

Note here that the invention is not restrictive to the embodiments as described above, and for implementation, the components can be modified without departing from the scope of the invention. Moreover, it is understood that numerous other embodiments can be devised by appropriate combinations of a plurality of components disclosed in the embodiments described above. For example, some of the components may be omitted from those others exemplified in the embodiments. Moreover, the components in the embodiments may be appropriately combined.

What is claimed is:

1. An image forming apparatus, comprising:
a laser beam source;
a laser beam source control unit configured to control the laser beam source based on image data;
a plurality of photoconductive members respectively corresponding to a plurality of colors;
a single piece of polygon mirror whose reflection surfaces are disposed in a rotation direction thereof with a plurality of different inclination angles respectively corresponding to the plurality of colors, and via a plurality of different optical paths respectively corresponding to the inclination angles, the polygon mirror scanning the photoconductive members with a light coming from the laser beam source sequentially for each of the colors in a main scanning direction;
a beam detector that is disposed adjacent to the photoconductive member on an upstream side of the photoconductive member in the main scanning direction; and
an adjustment data control unit configured to change, for output to the laser beam source control unit, in synchronization with a detection signal coming from the beam detector, color-based adjustment data for adjusting variations of an image quality parameter resulted from the optical paths and the photoconductive members varying with the colors.

2. The image forming apparatus according to claim 1, wherein
the image quality parameter is an image magnification on each of the photoconductive members in the main scanning direction produced by length variations of the optical paths from the polygon mirror to each of the photoconductive members,
the laser beam source control unit generates an image clock whose cycle is a pixel in the main scanning direction using a clock frequency based on frequency adjustment data, and drives the laser beam source based on the image data in synchronization with the generated image clock, and
the adjustment data control unit switches, for output to the laser beam source control unit, the frequency adjustment data set to each of the colors to make the photoconductive members to have the same image magnification in the main scanning direction.

3. The image forming apparatus according to claim 2, wherein
the laser beam source control unit generates the image clock by a phase-locked loop, and
the phase-locked loop generates the image clock by multiplying a reference clock of a predetermined frequency by a multiplication number based on the frequency adjustment data.

4. The image forming apparatus according to claim 3, wherein
the beam detector is disposed at a position where L>V·T is established, where L denotes a distance from the beam detector and an upstream end portion of an image forming area on the photoconductive member, V denotes a scanning speed on the photoconductive member in the main scanning direction, and T denotes a settling time of the phase-locked loop.

5. The image forming apparatus according to claim 3, wherein
the laser beam source control unit starts an operation of pulling the phase-locked loop after scanning is completed for an image forming area on one of the photoconductive members, and ends the operation of pulling the phase-locked loop by a time when scanning is started for another image forming area on the subsequent photoconductive member.

6. The image forming apparatus according to claim 1, wherein
the image quality parameter is a light attenuation amount in the optical paths from the polygon mirror to each of the photoconductive members,
the laser beam source control unit drives, to make the same an output laser power from the laser beam source as a laser power reference value based on laser power adjustment data, the laser beam source by adjusting the output laser power, and
the adjustment data control unit switches, for output to the laser beam source control unit, the laser power adjustment data set to each of the colors to make the photoconductive members to have the same light-receiving amount after light attenuation in accordance with the attenuation amount.

7. The image forming apparatus according to claim 6, wherein
the laser beam source control unit adjusts the output laser power in a period after scanning is completed for an image forming area on the photoconductive member but before the detection signal comes from the beam detector located adjacent to the photoconductive member to be scanned next.

8. The image forming apparatus according to claim 1, wherein
the image quality parameter is a distance between the photoconductive member and the beam detector,
the laser beam source drive unit adjusts a start position of image data in the main scanning direction by a delay amount based on position adjustment data, and
the adjustment data control unit switches, for output to the laser beam source control unit, the position adjustment data set to each of the colors to make the photoconductive members to have the same start position for the image data in the main scanning direction.

9. The image forming apparatus according to claim 1, wherein
the image quality parameter is a laser power distribution in the main scanning direction,
the laser beam source drive unit controls an output laser power of the laser beam source based on main scanning correction data to make substantially uniform the laser power distribution in the main scanning direction, and
the adjustment data control unit switches, for output to the laser beam source control unit, the main scanning correction data set to each of the colors to make the photoconductive members to have the same laser power distribution in the main scanning direction.

10. The image forming apparatus according to claim 1, wherein the beam detector is disposed adjacent to each of the photoconductive members on an upstream side of each of the photoconductive members in the main scanning direction.

11. A control method of an image forming apparatus, comprising:
controlling a laser beam source based on image data and color-based adjustment data;
sequentially scanning, by a single piece of polygon mirror whose reflection surfaces are disposed in a rotation direction thereof with a plurality of different inclination angles respectively corresponding to a plurality of colors, for each of the colors, a plurality of photoconductive members provided to each of the colors in a main scanning direction, with a light coming from the laser beam source via a plurality of different optical paths respectively corresponding to the inclination angles;
detecting a scanning timing in the main scanning direction by a beam detector that is disposed adjacent to the photoconductive member on an upstream side of the photoconductive member in the main scanning direction; and
switching, in synchronization with a detection signal coming from the beam detector, the color-based adjustment data for adjusting variations of an image quality parameter resulted from the optical paths and the photoconductive members varying with the colors.

12. The control method according to claim 11, wherein
the image quality parameter is an image magnification on each of the photoconductive members in the main scanning direction produced by length variations of the optical paths from the polygon mirror to each of the photoconductive members,
in the controlling, an image clock whose cycle is a pixel in the main scanning direction is generated using a clock frequency based on frequency adjustment data, and the laser beam source is driven based on the image data in synchronization with the generated image clock, and
in the sequentially scanning, the frequency adjustment data set to each of the colors is switched to make the photoconductive members to have the same image magnification in the main scanning direction.

13. The control method according to claim 12, wherein in the controlling
the image clock is generated by a phase-locked loop, and
the phase-locked loop generates the image clock by multiplying a reference clock of a predetermined frequency by a multiplication number based on the frequency adjustment data.

14. The control method according to claim 13, wherein the beam detector is disposed at a position where L>V·T is established, where L denotes a distance from the beam detector and an upstream end portion of an image forming area on the photoconductive member, V denotes a scanning speed on the photoconductive member in the main scanning direction, and T denotes a settling time of the phase-locked loop.

15. The control method according to claim 13, wherein in the controlling,
an operation of pulling the phase-locked loop is started after scanning is completed for an image forming area on one of the photoconductive members, and the operation of pulling the phase-locked loop is ended by a time when scanning is started for another image forming area on the subsequent photoconductive member.

16. The control method according to claim 11, wherein
the image quality parameter is a light attenuation amount in the optical paths from the polygon mirror to each of the photoconductive members,
in the controlling, to make the same an output laser power from the laser beam source as a laser power reference value based on laser power adjustment data, the laser beam source is driven by adjusting the output laser power, and
in the switching, the laser power adjustment data set to each of the colors is switched to make the photoconductive members to have the same light-receiving amount after light attenuation in accordance with the attenuation amount.

17. The control method according to claim 16, wherein
the laser beam source control unit adjusts the output laser power in a period after scanning is completed for an image forming area on the photoconductive member but before the detection signal comes from the beam detector located adjacent to the photoconductive member to be scanned next.

18. The control method according to claim 11, wherein
the image quality parameter is a distance between the photoconductive members and the beam detector,
in the controlling, a start position of image data in the main scanning direction is adjusted by a delay amount based on position adjustment data, and
in the switching, the position adjustment data set to each of the colors is switched to make the photoconductive members to have the same start position for the image data in the main scanning direction.

19. The control method according to claim 11, wherein
the image quality parameter is a laser power distribution in the main scanning direction,
in the controlling, an output laser power of the laser beam source is controlled based on main scanning correction data to make substantially uniform the laser power distribution in the main scanning direction, and
in the switching, the main scanning correction data set to each of the colors is switched to make the photoconductive members to have the same laser power distribution in the main scanning direction.

20. The control method according to claim 11, wherein the beam detector is disposed adjacent to each of the photoconductive members on an upstream side of each of the photoconductive members in the main scanning direction.
